(19) United States
(12) Patent Application Publication
(10) Pub. No.: US 2004/0138323 A1
(43) Pub. Date: Jul. 15, 2004

(54) Porous polymers

(76) Inventors: Martina Heide Stenzel-Rosebaum, Maroubra New South Wales (AU); Thomas Davis, New South Wales (AU)

Correspondence Address: Albert P Halluin, Howrey Simon Arnold & White, 301 Ravenswood Avenue, Box NO 34, Menlo Park, CA, 94025, US

(21) Appl. No.: 10/451,807

(22) PCT Filed: Dec. 19, 2001
(86) PCT No.: PCT/AU01/01639

(30) Foreign Application Priority Data
Dec. 19, 2000 (AU) PR 2161

(51) Int. Cl. C08J 9/00

(52) U.S. Cl. 521/142

(57) ABSTRACT

This invention relates to porous polymer films and methods for their preparation. In particular the present invention relates to a method for preparing porous polymer films using ATRP or RAFT polymerisation, or using graft polymers prepared by living/controlled polymerisation or using microgels, methods for enhancing the uniformity of pore size in porous polymer films or for preparing porous polymer films having regularly spaced pores of substantially regular pore size, and methods for facilitating the casting of porous polymer films or for controlling or increasing the pore size of porous polymer films.

### BACKGROUND OF THE INVENTION

1. Field of the Invention

The present invention relates to porous polymer films and methods for their preparation. In particular the present invention relates to a method for preparing porous polymer films using ATRP or RAFT polymerisation, or using graft polymers prepared by living/controlled polymerisation or using microgels, methods for enhancing the uniformity of pore size in porous polymer films or for preparing porous polymer films having regularly spaced pores of substantially regular pore size, and methods for facilitating the casting of porous polymer films or for controlling or increasing the pore size of porous polymer films.

2. Description of the Prior Art

The formation of self-organised honeycomb morphology in porous polymer films has been described by Widawski et al. in Nature 369, 387-389 (1994). In this paper, polymer films are generated with an essentially monodisperse pore size with the pores organised spontaneously into periodic hexagonal arrays. The films, which are 10-30μm thick, are produced by evaporating solutions of star-shaped polystyrene or polystyrene or polystyrene-polyparaphenylene block copolymers in carbon disulphide under a flow of moist gas. Empty spherical shells, about 0.2-10 μm in diameter appear spontaneously in a hexagonal array, and the cells are open at the film surface. The authors note that the use of star polymers, or of polymeric micelles, seems to be essential to obtain the desired morphology, and propose that the porous films may have applications in the controlled release of drugs, as materials with useful optical properties, as moulds or scaffolding for forming ordered microstructures, and as model substrates for surface science. The authors also note a relationship between the size of the spherical cells and the relative molecular masses (Mr) of the star polymer, and a relationship between the length of the arms of the star polymer and the regularity of the spheres.

The preparation of films having self-organised honeycomb morphology from amphiphilic copolymers and polyion complexes for use as substrates for cell culture was described by Nishikawa el al. in Materials Science and Engineering C8-9 (1999) 495-500 and C10 (1999) 141-146. The honeycomb films were found to provide for better cell adhesion than corresponding non-porous films. The authors noted that passive control of pore size was possible by controlling the polymer concentration of the casting solution and the humidity.

The preparation of micrometer size honeycomb patterns from a range of polymers and compositions, including amphiphilic polyion complexes, non-amphiphilic polystyrene, polyisoprene block copolymers, mixtures of a TiO₂ precursor and low molecular weight amphiphile, and mixtures of linear polystyrene and amphiphilic polyion complex as a stabiliser, was described by Karthmus et al. in Langmuir 16(15) 6071-6076 (2000). The authors suggest that the regular pattern of pores in the thin films produced was a result of stabilisation of the water droplets formed on the surface of the polymer solution during film preparation.

De Boer et al. in Adv. Mater. 2000, 12, No. 21, 1581-1583 describe the modification of a rigid rod polymer with a nitroxide containing derivative, 2,2,6,6-tetramethylpiperidinyl-N-oxyl, to enable the synthesis of a coil using nitroxide radical polymerisation. The resultant rod-coil polymer was then used to prepare a honeycomb film on a substrate which was used as a template for forming a regular array of aluminium cups. Prior to deposition of the aluminium the porous polymer was exposed to blue light which caused photocrosslinking of the exposed surfaces. This allowed the top layer to be removed by peeling off with Scotch™ tape to expose an array of aluminium cups. The remaining unexposed film was removed by washing with an organic solvent to leave a hexagonally packed array of aluminium cups attached to the surface of the substrate.

Ookura et al. in Mol. Cryst. and Liq. Cryst. 1999, 337, 461-464 describe the adhesion of cells to a honeycomb film prepared from a polyion-complex described by Nishikawa et al. (supra). The stability of the film in phosphate buffer was improved by crosslinking the complex with a bisazido derivative.

It has now been found that it is possible to increase the range of polymers and the range of monomers available for preparing polymers suitable for casting, to control, enhance or otherwise affect the pore size and/or pore regularity of porous polymer films, and to enhance or facilitate the casting process.

### SUMMARY OF THE INVENTION

Accordingly in one aspect the present invention provides a method for preparing a porous polymer film comprising:

providing a solution of star, block or graft polymer in a casting solvent, said polymer being prepared by ARTP or RAFT polymerisation, and

casting a porous polymer film from said solution.

In a second aspect the invention provides a method for preparing a porous polymer film comprising:

providing a solution of a graft polymer in a casting solvent, said polymer being preparing by living/controlled polymerisation, and

casting a porous polymer film from said solution.

In a third aspect the invention provides a method of preparing a porous polymer film comprising:

providing a solution of a microgel in a casting solvent, and

casting a porous polymer film from said solution.

In a fourth aspect the invention provides a method of enhancing the uniformity of pore size in porous polymer film prepared from a star, block or graft polymer preparing by living/controlled polymerisation comprising:

incorporating a linear polymer into a solution of said polymer in a casting solvent, and

casting a porous polymer film from said solution.

In a fifth aspect the present invention provides a method of preparing a porous polymer film having regularly spaced pores of substantially uniform pore size comprising:

providing a solution of star, block or graft polymer in a casting solvent, said polymer being prepared by ATRP, and

casting said porous polymer film from said solution.

In a sixth aspect the present invention provides a method of facilitating the casting of a porous polymer film comprising:

providing a solution of said star, block or graft copolymer prepared by living/controlled polymerisation and having a low polydispersity index, and

casting a porous polymer film from said solution.

In a seventh aspect there is provided a method of controlling the pore size and/or pore regularity of a porous polymer film comprising:

providing a star, block or graft copolymer in a solvent, said polymer being prepared by ATRP or RAFT polymerisation,

modifying at least a portion of ATRP or RAFT end groups of said polymer to provide desired end groups, and

casting a porous polymer film from said solvent or from a solution of the polymer in a solvent suitable for casting.

In an eight aspect the present invention provides a method of increasing the size of the pores of a porous polymer film prepared from an amphiphilic diblock copolymer prepared by living/controlled polymerisation, said method comprising:

increasing the size of the hydrophilic block of said amphiphilic diblock copolymer, and

casting a porous polymer film from a solution of the modified polymer in a casting solvent.

In a ninth aspect there is provided a method of increasing the size of the pores of a porous polymer film prepared from a star polymer prepared by living/controlled polymerisation, said method comprising:

providing a solution of said star polymer and a long chain linear polymer in a casting solvent, and

casting a porous polymer film from said solution,

wherein the long chain linear polymer is of such a size and is present in such an amount as to increase the pore size of the porous polymer film relative to the pore size of a film cast under identical conditions in the absence of said long chain linear polymer.

The porous films of the present invention may be useful as, or in the preparation of, membranes, drug delivery devices, solid supports for organic synthesis, solid supports for cell growth, bio interfaces, catalysts, electrodes, separation devices, photonic band gap crystals and the like comprising or consisting of porous polymer films as hereinabove described.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

### DETAILED DESCRIPTION OF THE INVENTION

The term “star polymer” as used herein refers to a polymer having a central core and three or more radiating polymeric arms. The central core may be any suitable multifunctional compound capable of supporting three or more polymeric arms. Examples of compounds capable of providing suitable cores include, but are not limited to, saccharides, including mono-, di- and polysaccharides, aromatic and heteroaromatic ring compounds having three or more reactive functionalities, non-aromatic carbocyclic or heterocyclic compounds having at least three reactive sites, ring compounds which include combinations of aromatic, heteroaromatic, non-aromatic carbocylic or heterocyclic rings and have at least three reactive sites, macromolecular systems such as dendrimers, hyperbranched polymers, microgels, core-shell systems and colloidal latexes and particles, that have at least three reactive sites on their surfaces.

Examples of suitable monosaccharides include, but are not limited to, abequose, iduronic acid, allose, lyxose, altrose, mannose, apiose, muramic acid, arabinose, neuraminic acid, arabinitol, N-acetylneuraminic acid, 2-deoxyribose, N-acetyl-2-deoxyneur-2-enaminic acid, fructose, N-glycoloylneuraminic acid, fucose, 3-deoxy-D-manno-oct-2-ulosonic acid, fucitol, rhamnose, galactose, 3,4-di-ribose, glucose, ribose 5-phosphate, glucosamine, ribulose, 2,3-diamino-2,3-dideoxy-D-glucose, sorbose, glucitol, tagatose, N-acetylglucosamine, talose, glucuronic acid, xylose, ethyl glucopyranuronate, xylose, gulose, 2-C-methylxylose and idose. Preferably the saccharides are in cyclic form.

Examples of suitable disaccharides include, but are not limited to, sucrose, lactose and maltose.

Examples of suitable polysaccharides include, but are not limited to, α-cyclodextrine, beta-cyclodetran, cellulose, amylose pectin and lectin.

Further, those experienced in the art would appreciate the diversity of saccharide like molecules available from synthetic or natural sources.

Examples of suitable aromatic and heteroaromatic ring compounds include, but are not limited to, benzene, biphenyl, terphenyl, quaterphenyl, naphthalene, tetradyronaphthalene, 1-benzylnaphthalene, anthracene, dihydroanthracene, benzanthracene, dibenzanthracene, phenanthracene, perylene, pyridine, 4-phenylpyridine, 3-phenylpyridine, thiophene, benzothiophene, naphthothiophene, thianthrene, furan, pyrene, isobenzofuram, chromene, xanthene, phenoxathiin, pyrrole, imidazole, pyrazole, pyrazine, pyrimidine, pyridazine, indole, indolizine, isoindole, purine, quinoline, isoquinoline, phthalazine, quinoxaline, quinazoline, pteridine, carbazole, carboline, phenanthridine, acridine, phenanthroline, phenazine, isothiazole, isooxazole, phenoxazine and the like. The terms “aromatic” and “heteroaromatic” include such ring compounds which are “pseudoaromatic”. The term “pseudoaromatic” refers to a ring system which is not strictly aromatic, but which is stabilised by means of delocalisation of π electrons and behaves in a similar manner to aromatic rings. Examples of pseudoaromatic rings include but are not limited to furan, thiophene, pyrrol and the like. These ring compounds must possess at least three reactive functional groups to allow attachment or growth of polymeric arms. Examples of suitable reactive functional groups include hydroxy, mercapto, carboxylic acid, halide, boronic acid, azido, epoxy, isocyano, vinyl, allyl, amino, imino, acetyleno, carbamoyl, carboximidyl, sulfo, sulfinyl, sulfinimidyl, sulfinohydroximyl, sulfonimidyl, sulfoniimidyl, sulfonohydroximyl, sultamyl, phosphinyl, phosphinimidyl, phosphonyl, dihydroxyphosphanyl, hydroxyphosphanyl, phosphono, hydrohydroxyphosphoryl, allophanyl, guanidino, hydantoyl, ureido, ureylene and reactive derivatives of these functional groups. These groups may be attached directly to the ring system or may be attached via a spacer arm, such as a C₁₋₆ alkylene group or hydrophilic oligomeric ether. Methods for functionalising aromatic ring systems are well described in the literature, for example see the chapter on electrophilic aromatic substitution in March J., “Advanced Organic Chemistry: Reactions, Mechanisms, and Structure”, 2^{nd} 1997 McGraw-Hill.

Examples of suitable non-aromatic carbocyclic and heterocyclic compounds include, but are not limited to, 1-3 membered cycloalkyl, cycloalkenyl or cycloalkynyl compounds, such as cyclopenta-1,4-diene, hex-1,4,diene, cyclohexa-1,3-diene, cyclohexa-1,4-diene, cyclohepta-1,3-diene, cyclohepta-1,3,5-triene and cycloocta-1,3,5,7-tetraene, 1-3 membered heterocyclyl groups, such as 3-isopyrrole, 1,3-dithiole and 1,2,3-oxathiole which have at least three reactive sites. Examples of suitable cores composed of combinations of rings include indene, coumarin and 1,4-benzisoxazine . The reactive sites may take the form of a reactive functional group as described above in relation to the aromatic and heteroaromatic compounds, or may take the form of a double or triple bond within the ring. Depending on how the arm is attached to or synthesised from the core, the double or triple bond may provide attachment positions for one or two arms.

Examples of suitable macromolecular systems include reactive variants of, but are not limited to, dendrimers, dendrigrafts and other dendritic architecture, such as Starburst PAMAM & PAMAM-OH of generation 1 to 4 as well as polypropylenimine (DAB-Am) systems of generation 1 to 4, microgels such as described in Macromolecular Rapid Communications, 1997, 18, 755-760, core-shell systems such as water-soluble shell crosslinked knedels (SCK) as described in J. Am. Chem. Soc., 1997, 119,6656 and colloidal latexes and particles as described in Polymer Colloids: A Comprehensive Introduction; Academic Press; ISBN: 0122577450. C60 presents another core or scaffold from which star polymers of the present invention may be prepared.

The polymeric arms are grown from the reactive group of the core in a polymerisation process using appropriate monomers. In the process of the invention the arms are grown from the core in a free radical polymerisation process involving one or more olefinically unsaturated monomers. Particular advantages are obtained, especially in relation to improved control over the polymerisation process, improved polydispersity index and improved control over the construction of block copolymeric arms can be obtained if the arms are grown from the core using a “living/controlled radical polymerisation” process.

The terminology “living/controlled” radical polymerisation is discussed in T. R. Darling, T. P. Davis, M. Fryd, A. A. Gridnev, D. M. Haddleton, S. D. Ittel, R. R. Matheson, Jr, G. Moad, E. Rizzardo. Living Polymerization: Rationale for Uniform Terminology. J. Polym. Sci. Part A: Polym. Chem. 38, 1706-1709 (2000). The synthetic approach has the following features:

(a) The main chain carrier is a carbon centred radical;

(b) The control over the reaction is exerted by a reversible capping mechanism so that there is an equilibrium between dormant and active chains. This has the effect of reducing the overall radical concentration, thereby suppressing radical-radical termination events. In reversible-addition-fragmentation transfer (RAFT) polymerisation this is achieved by a dithioester (or related compound), in atom transfer radical polymerization (ATRP) this is achieved by a halogen atom and in nitroxide mediated radical polymerization (NMRP) it is achieved with a nitroxide molecule.

(c) The molecular weight of the polymer grows in a linear fashion with time/conversion.

(d) “Living” polymers are distinguished from dead polymers by being able to grow whenever additional monomer is supplied.

In a preferred process according to the invention the star polymer is prepared by preparing a core functionalised with three or more groups capable of promoting living/controlled radical polymerisation. This can be done through direct functionalisation of the core or by reacting functional groups on or attached to the core with an agent capable of providing for living/controlled radical polymerisation. Upon functionalisation the core effectively becomes an agent for living/controlled radical polymerisation, for example a RAFT agent, an ATRP agent or an NMRP agent. Procedures for introducing such functionality into the core are described in the prior art. For example, a RAFT agent may be prepared by reacting a core functionalised with three or more halide groups, with a suitably substituted carbondisulfide moiety. The chain transfer constant of the resultant RAFT agent will be dependent on the substituent on the carbondisulfide. For example, a benzyl substituent provides a RAFT agent having a higher chain transfer constant than a phenyl group. In general, RAFT agents which provide radical intermediates (formed during the polymerisation process when both sulfur atoms are substituted) which are more stable tend to provide lower chain transfer constants. It is also possible to attach a RAFT group to a core which has hydroxy functionalities by first preparing a RAFT agent which has a group reactive with an hydroxy group, for example an acid halide group. Following attachment to the core the RAFT group should be free to control the polymerisation.

Agents for ATRP where first described by Matjasewski (Macromolecules 1995, 28, 7901, WO96/30421) and may now be prepared in a number of different ways, and using a number of different systems, for example the Haddleton system (using bromide) and the Sawamoto system (using iodide). For the Haddleton system (WO97/47661), for example, a core which has hydroxy groups can be esterified with a reagent such as bromoisobutyrylbromide to provide isobutyryl/bromide functional groups. For the Sawamoto system (Macromolecules 1995, 28, 1721 and Macromolecules 1997, 30, 2244), these groups can be converted to the corresponding iodides by exchange of bromide with iodide in acetone as described by Finkelstein (March J., “Advanced Organic Chemistry: Reactions, Mechanisms, and Structure”, 2^{nd} 1997 McGraw-Hill, Chapter 10).

The C—O bond of alkoxyamines and similar species used in NMRP processes is relatively weak and undergoes reversible homolysis on heating to afford an alkyl radical and a stable nitroxide. The afforded reactive carbon centred radical initiates polymerisation while the stable nitroxide reacts with the propagating radical by primary radical termination to form a new oligo or polymeric alkoxyamine. The effectiveness of this process is dependant on the structure of the alkoxyamine. A variety of useful nitroxide reagents include 2,2,6,6-tetramethyalpiperidine-N-oxyl (TEMPO), 4-hydroxy-2,2,6,6-tetramethylpiperidine-N-oxyl (OH-TEMPO), 4-oxo-2,2,6,6-tetramethylpiperidine-N-oxyl (oxo-TEMPO) and related systems as described in EP135280. Further, a variety of useful alkoxyamines have been described in Journal of the American Chemical Society, 1999, 121, 3904.

The monomers useful in the preparation of the star polymers of the invention depend on the particular polymerisation method being used. For living/controlled radical polymerisation the monomers are selected from olefinically unsaturated monomers. These may be any type of unsaturated monomer from low molecular weight monomers, such as vinyl, to large macromers. These monomers include those of formula I:

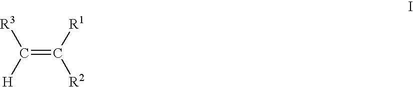

where R¹ and R³ are independently selected from the group consisting of hydrogen, halogen, optionally substituted C₁-C₄ alkyl wherein the substituents are independently selected from the group consisting of hydroxy, —CO₂H, —CS₂H, —CO₂R′, —CS₂R′, —COR′, —CSR′, —CSOH, —CSOR′, —COSH, —COSR′, —CSOH, —CSOR′, —CN, —CONH₂, —CONHR′, —CONR′₂, —OR′, —SR′, —O₂CR′, —S₂CR′, —SOCR′, and —OSCR′; and

R² is selected from the group consisting of hydrogen, R′, —CO₂H, —CS₂H, —CO₂R′, —CS₂R′, —COR′, —CSR′, —CSOH, —CSOR′, —COSH, —COSR′, —CSOH, —CSOR′, —CN, —CONH₂, —CONHR′, —CONR′₂, —OR′, —SR′, —O₂CR′, —S₂CR′, —SOCR′, and —OSCR′;

where R′ is selected from the group consisting of optionally substituted C₁-C₁₈ alkyl, C₂-C₁₈ alkenyl, aryl, heteroaryl, carbocyclyl, heterocyclyl, aralkyl, heteroarylalkyl, alkaryl, alkylheteroaryl, and polymer chains wherein the substituents are independently selected from the group consisting of alkyleneoxidyl (epoxy), hydroxy, alkoxy, acyl, acyloxy, formyl, alkylcarbonyl, carboxy, sulfonic acid, alkoxy- or aryloxy-carbonyl, isocyanato, cyano, silyl, halo, amino, or a substituent of biological origin or activity, such as saccharide, peptide, antibody, nucleic acid or the like;

including salts, inner salts, such as zwitterions and derivatives thereof.

Examples of monomers include, but are not limited to, maleic anhydride, N-alkylmaleimide, N-arylmaleimide, dialkyl fumarate and cyclopolymerisable monomers, acrylate and methacrylate esters, acrylic and methacrylic acid, styrene, acrylamide, methacrylamide, and methacrylonitrile, mixtures of these monomers, and mixtures of these monomers with other monomers. As one skilled in the art would recognise, the choice of comonomers is determined by their steric and electronic properties. The factors which determine copolymerisability of various monomers are well documented in the art. For example, see: Greenley, R Z. in Polymer Handbook 3^{rd} Edition (Brandup, J., and Immergut, E. H Eds.) Wiley: New York. 1989 pII/53.

Specific examples of monomers or comonomers include the following: methyl methacrylate, ethyl methacrylate, propyl methacrylate (all isomers), butyl methacrylate (all isomers), 2-ethylhexyl methacrylate, isobomyl methacrylate, methacrylic acid, benzyl methacrylate, phenyl methacrylate, methacrylonitrile, alpha-methylstyrene, methyl acrylate, ethyl acrylate, propyl acrylate (all isomers), butyl acrylate (all isomers), 2-ethylhexyl acrylate, isobomyl acrylate, acrylic acid, benzyl acrylate, phenyl acrylate, acrylonitrile, styrene, functional methacrylates, acrylates and styrenes selected from glycidyl methacrylate, 2-hydroxyethyl methacrylate, hydroxypropyl methacrylate (all isomers), hydroxybutyl methacrylate (all isomers), N,N-dimethylaminoethyl methacrylate, N,N-diethylaminoethyl methacrylate, triethyleneglycol methacrylate, itaconic anhydride, itaconic acid, glycidyl acrylate, 2-hydroxyethyl acrylate, hydroxypropyl acrylate (all isomers), hydroxybutyl acrylate (all isomers), N,N-dimethylaminoethyl acrylate, N,N-diethylaminoethyl acrylate, triethyleneglycol acrylate, methacrylamide, N-methylacrylamide, N,N-dimethylacrylamide, N-tert-butylmethacrylamide, N-n-butylmethacrylamide, N-methylolmethacrylamide, N-ethylolmethacrylamide, N-tert-butylacrylamide, N-n-butylacrylamide, N-methylolacrylamide, N-ethylolacrylamide, vinyl benzoic acid (all isomers), diethylamino styrene (all isomers), alpha-methylvinyl benzoic acid (all isomers), diethylamino alpha-methylstyrene (all isomers), p-vinylbenzene sulfonic acid, p-vinylbenzene sulfonic sodium salt, trimethylsilyl methacrylate, trimethoxysilylpropyl methacrylate, triethoxysilylpropyl methacrylate, tributoxysilylpropyl methacrylate, dimethoxymethylsilylpropyl methacrylate, diethoxymethylsilylpropyl methacrylate, dibutoxymethylsilylpropyl methacrylate, diisopropoxymethylsilylpropyl methacrylate, dimethoxysilylpropyl methacrylate, diethoxysilylpropyl methacrylate, dibutoxysilylpropyl methacrylate, diisopropoxysilylpropyl methacrylate, trimethylsilyl acrylate, trimethoxysilylpropyl acrylate, triethoxysilylpropyl acrylate, tributoxysilylpropylacrylate, dimethoxymethylsilylpropyl acrylate, diethoxymethylsilylpropyl acrylate, dibutoxymethylsilylpropyl acrylate, diisopropoxymethylsilylpropyl acrylate, dimethoxysilyipropyl acrylate, diethoxysilylpropyl acrylate, dibutoxysilylpropyl acrylate, diisopropoxysilylpropyl acrylate, vinyl acetate, vinyl butyrate, vinyl benzoate, vinyl chloride, vinyl fluoride, vinyl bromide, maleic anhydride, N-phenylmaleimide, N-butylmaleimide, N-vinylpyrrolidone, 2,2-dimethyl azlactone, N-vinylcarbazole, butadiene, isoprene, chloroprene, ethylene, propylene, 2-methacryloyloxy ethyl phosphorylcholine, 2-acryloyloxy ethyl phosphorylcholine, 3-methacryloylamino propyl dimethyl-3-sulfopropyl ammonium hydroxide inner salt, 2-methacryloyloxy ethyl dimethyl-3-sulfopropyl ammonium hydroxide inner salt, trimethylsilylethyl methacrylate, ethoxyethyl methacrylate, N-3-N′N′-dicarboxymethyl aminopropyl methacrylamide, tetrahydrofurfuryl methacrylate, glycerol methacrylate, 2-methacryloylethyl glucoside.

The arms of the star polymer may be composed of units of a single monomer type, or may be copolymer of two or more different monomers. The desired functionality in the arm is advantageously provided by or derived from the capping group of the polymeric arm, although it may be incorporated in the form of a functional/reactive co-monomer near the outer end of the arm, for example a glycidyl methacrylate monomer which would provide a reactive epoxide group. An example of a reactive group derived from a RAFT capping group would be a thiol group formed by modification of the thiol ester, and for ATRP being an amine formed by the modification of the terminal bromine atom. While not essential, it is preferred that each of the arms of the star polymer is functionalised with an end group capable of undergoing modification prior to casting of the porous film.

The term “block polymer” as used herein refers to a block copolymer containing two or more polymerised blocks of sections of like monomer. The block copolymers may be diblock copolymers, or may have three or more blocks. Each block may be different or the blocks may alternate.

The block copolymers useful in accordance with the present invention are generally diblock polymers of formula -(A)ₘ(B)ₙ- where A represents the polymerised residue of the monomer of one block, B represents the polymerised residue of the monomer of the second block, and m and n represent the number of repeat units of monomers A and B respectively. Preferably monomers A and B are selected to provide a block copolymer which has amphiphilic characteristics, for example by having blocks of different solubilities, i.e. where monomer A is a hydrophobic monomer and monomer B is a hydrophobic monomer, or where monomers A and B have different solubilities in the casting solvent. The preparation of porous polymer films have a regular arrangement of pores of substantially uniform size from block copolymers is described in the prior art. Examples of such suitable copolymers, —(A)ₘ(B)ₙ—, include the following:

| Reference | A | B |
|---|---|---|
| Widawski et al (supra) | Polystyrene | Polyparaphenylene |
| Francois et al Adv. Mater. | Polystyrene | Polyparaphenylene |
| 1995, 7, 1041-1044 | Polystyrene | Polythiophene |
| | Polystyrene | Poly-3-hexylthiophene |
| | | (doped with FeCl₂) |
| Nishikawa et al (supra) | 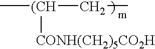 | 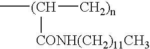 |
| Karthaus et al Langmuir | Polystyrene | Polyisoprene |
| 1b, 6071-6076 | | |
| Stolmach et al J. Am. | Poly(2,5-dioctyloxy-1,4- | Poly(styrene-stat- |
| Chem. Soc. 2000 122 | phenylenevinylene) | chloromethylstyrene) |
| 5464-5472 | | (C₆₀ functionalised) |

With the exception of the diblock copolymers prepared by Stalmach et al, none of the diblock copolymers were prepared using free radical means, or living/controlled radical polymerisation. At least one block of the block copolymers of the present invention should be synthesised using living/controlled free radical polymerisation. More preferably the whole block copolymer is synthesised using living/controlled polymerisation. It is to be understood that the nature of the end groups of the block polymers of the present invention will depend on the nature of the initiators used, and the type of living/controlled free radical polymerisation employed. These groups can be selected to enhance the polymers ability to form micellular structures.

The term “graft polymer” as used herein refers to a graft polymer comprising a polymeric backbone, which may be of one monomer type or may be a block copolymer, to which a further polymeric chain, which may also be of one monomer type or may be a block copolymer, is grafted, usually through pendent reactive or polymerisable groups present on the polymeric backbone, or through unsaturation in the polymeric backbone. The polymeric backbone is prepared using living/controlled free radical polymerisation techniques. The grafted polymer may be introduced using any suitable technique. The polymer to be grafted may be prepared separately and attached to the polymeric backbone through reaction of a reactive group present on the graft polymer with a complementary reactive group on the backbone. The term “complementary” as used herein when referring to functional groups means that two functional groups are capable of reacting together to form a stable bond. The bond must be stable to the conditions to which the functionalised core, star polymer or porous film are to be subjected. Examples of functional groups which are complementary are hydroxy groups and carboxylic acid groups (which will produce ester bonds) epoxide groups and amine groups (which will produce C—N bonds), thiols and Michael acceptors (which will produce C—S bonds) and the like. For example, if the core is functionalised with an hydroxy group, the inner end of the polymeric arm could be functionalised with a carboxylic acid group, or a derivative, such as an ester, of the carboxylic acid group. In some cases, such as vinyl groups, the complementary functional groups can be identical. A person skilled in the art would be able to select appropriate functionalities to attach the graft to the backbone. In another embodiment the graft polymer is polymerised onto the polymeric backbone using a suitable polymerisation technique. An examples of a polymer to be grafted onto a polymeric backbone is polystyrene.

The monomers useful in the preparation of the block polymers and the polymeric backbones of the graft polymers according to the present invention include olefinically unsaturated monomers, such as those described above in relation to the preparation of the arms of the star polymers.

Such block copolymers and graft copolymers should preferably have the ability to arrange themselves in the casting solvent in the form of micelles as such an arrangement is believed to facilitate the formation of regular pores of substaritially uniform size.

As used herein the terms “uniformity of pore size”, “uniform pore size”, pores of substantially uniform size” and the like mean that the porous polymer film has a region or regions within which there is little variation of the pore diameters. This can be assessed by measuring the Gini coefficient for the films, or for regions of the film. A Gini coefficient approaching zero indicates a uniform pore size, for example a Gini coefficient of less than 0.3, more preferably less than 0.2.

As used herein a reference to “regularity of pores”, “regularity of spacing of pores” and “pore regularity” means that the pores are located in a substantially regular arrangement. The regular arrangement of the pores can be assessed usually with appropriate magnification equipment. In a particularly idealised situation the arrangement of pores would be in, or would approach, a hexagonal close packed array.

Preferably the polymers used to prepare the porous film of the present invention will have a polydispersity index (PDI) of between 1 and 3, and a Mₙ of between 5,000 and 250,000.

It has been found in casting porous films from solutions of star polymers to produce self-organised honeycomb morphology that the presence of short chain linear polymer (which can form by polymerisation initiated at polymerisation centres other than those associated with the functionalised core) can interfere with the self-organisation of the honeycomb morphology of the film, as can the presence of other small or short chain molecules. In contrast the presence of some long chain polymers, for example those of molecular weight greater than about 5000, can have a beneficial effect on the uniformity of the honeycomb structure. In addition the inclusion of such linear components in solutions of star polymers may improve the mechanical properties of the film, in reducing the brittleness of the resultant film.

The polymerisation process may be carried out in any suitable solvent, the selection of which will depend on the particular system to be polymerised. Examples of organic solvents useful for preparing the living polymerisation agents or for performing the polymerisation reaction include, but are not limited to, water, methanol, acetone, dichlorobenzene, dimethyl formamide, toluene, methoxybenzene, diphenylether, dimethoxybenzene, trimethoxybenzene, ethylene carbonate, xylene, benzonitrile and pyridine. Preferably the polymerisation is performed without solvent, where the monomer acts as the solvent.

Initiating radicals for free radical polymerisation processes can be generated by any suitable method, such as the thermally induced homolytic scission of a suitable compound(s) (thermal initiators such as peroxides, peroxyesters, or azo compounds), the spontaneous generation from monomer (e.g. styrene), redox initiating systems, photochemical initiating systems or high energy radiation such as electron beam, X- or gamma-radiation. The initiating system is chosen such that under the reaction conditions there is no substantial adverse interaction of the initiator or the initiating radicals with other monomers or agents under the conditions of the polymerisation. The initiator should also have the requisite solubility in the reaction medium or monomer mixture.

Thermal initiators are chosen to have an appropriate half life at the temperature of polymerization. These initiators can include one or more of the following compounds:

2,2′-azobis(isobutyronitrile) (“AIBN”), 2,2′-azobis(2-cyano-2-butane), dimethyl 2,2′-azobisdimethylisobutyrate, 4,4′-azobis(4-cyanopentanoic acid), 1,1′-azobis(cyclohexanecarbonitrile), 2-(t-butylazo)-2-cyanopropane, 2,2′-azobis[2-methyl-N-(1,1)-bis(hydroxymethyl)-2-hydroxyethyl]propionamide, 2,2′-azobis[2-methyl-N-hydroxyethyl)]-propionamide, 2,2′-azobis(N,N′-dimethyleneisobutyramidine)dihydrochloride, 2,2′-azobis(2-amidopropane)dihydrochloride, 2,2′-azobis(N,N′-dimethyleneisobutyramide), 2,2′-azobis(2-methyl-N-[1,1,-bis(hydroxymethyl)-2-hydroxyethyl]propionamide), 2,2′-azobis(2-methyl-N-[1,1-bis(hydroxymethyl)ethyl]propionamide), 2,2′-[2-methyl-N-(2-hydroxyethyl)propionamide], 2,2′-azobis(isobutyramide)dihydrate, 2,2′-azobis(2,2,4-trimethylpentane), 2,2′-azobis(2-methylpropane), t-butyl peroxyacetate, t-butyl peroxybenzoate, t-butyl peroxyoctoate, t-butyl peroxyneodecanoate, t-butylperoxy isobutyrate, t-amyl peroxypivalate, t-butyl peroxypivalate, di-isopropyl peroxydicarbonate, dicyclohexyl peroxydicarbonate, dicumyl peroxide, dibenzoyl peroxide, dilauroyl peroxide, potassium peroxydisulfate, ammonium peroxydisulfate, di-t-butyl hyponitrite, dicumyl hyponitrite.

Photochemical initiator systems are chosen to have the requisite solubility in the reaction medium or monomer mixture and have an appropriate quantum yield for radical production under the conditions of the polymerisation. Examples include benzoin derivatives, benzophenone, acyl phosphine oxides, and photo-redox systems.

Redox initiator systems are chosen to have the requisite solubility in the reaction medium or monomer mixture and have an appropriate rate of radical production under the conditions of the polymerization; these initiating systems can include oxidants, such as potassium peroxydisulfate, hydrogen peroxide, t-butyl hydroperoxide, or reductants, such as iron (II), titanium (III), potassium thiosulfite, potassium bisulfite, or combinations thereof.

Other suitable initiating systems are described in the literature, such as, for example, Moad and Solomon “The Chemistry of Free Radical Polymerisation”, Pergamon, London, 1995, pp 53-95. Other experimental conditions may be varied accordingly, as described in the art.

The polymerisation process may also be mediated by a combination of transition metal halide, such as CuBr, CuCl in oxidation state I or II, an alkyl halide and a suitable ligand. Examples of some ligands routinely employed in ATRP include bipyridine and alkyl-substituted bipyridine derivatives, alkylpyridine imines, for example N-(propyl)-2-pyridylmethanimine and triamines and tetraamines, for example N,N,N′,N″,N″-pentamethyldiethylenetriamine and tris(2-(dimethylamino)ethyl(amine). Useful combinations of these components have been described in detail by Matjasewski (Macromolecules 1995, 28, 7901, WO96/30421), Haddleton (WO97/47661) and Sawamoto (Macromolecules 1995, 28, 1721 & ibid 1996, 30, 2244).

Preferably the porous polymer films of the present invention have a self-organised honeycomb morphology. By this is meant that the polymer films have a regular array of pores of substantially uniform size. Such morphology has been described by Widanski et al. (Supra) and subsequent references. The porous film may have an open or closed pore structure and the pores may be of a size which suits the particular application.

The porous polymer films of the present invention may be cast from a solvent using techniques known to the art, such as those described by Widawski et al. (Supra), Ishikawa et al. (Supra) or Karthaus et al. (Supra). Generally the polymers are dissolved in a solvent, such as an organic solvent, which as well as being a solvent for the star polymer has a volatility sufficient for the casting process, before being spread on a surface. Examples of suitable solvents include carbon disulfide or chloroform. Preferably the surface is a flat surface, such as a glass, silicon wafer, metal or metal coated surfaces, plastic surfaces, such as polyolefins, which include but are not limited to, polypropylene, polyethylene, polytetrafluoroethylene and the like. The polymer may be cast onto a microtitre plate to form an array of films. Casting of the polymer could also be performed onto a surface via the wide variety of printing techniques known in the art, such as ink jet printing, contact printing such as piezoelectric printing, stamping, such as PDMS stamping and the like. Further, the film could be applied to non-flat objects, such as cylinders and moulded articles by such processes. Dip coating methodologies could be invoked for the coating of such non-flat surfaces. It may also be possible to cast porous polymer films on the surface of a liquid.

The concentration of the polymer in the solution will generally be between 0.5 and 10% by weight, and the thickness of the polymer solutions on the surface is generally between 0.1 and 1 mm. The organic solvent is evaporated under an atmosphere of a liquid which is a non-solvent for the polymer and which is immiscible with the casting solvent. The liquid must have a vapour pressure in the atmosphere which allows the formation of a porous morphology on evaporation. Preferably the liquid is water. In this embodiment the polymer is cast under humid conditions, generally greater than 50% humidity, to provide polymer films with a self-organised honeycomb morphology. Without wishing to be limited by theory, it is believed that the humidity, which is generally caused by a flow of humid air over the surface of the polymer solution, results in the formation of a hexagonal array of water droplets on the surface of the polymer solution. Coalescence of the water droplets is prevented by the polymer such that evaporation of the solvent and of the water produces a polymer film having an ordered array of micropores. The size of the pores can generally be controlled within the size range of 0.2 to 10 micrometres, although selection of particular conditions and polymers, may result in smaller pore sizes. The size of the pores can also be related to the concentration of the polymer in the solvent and the humidity. According to the present invention it has been found that increasing the molecular weight (M_{w} or Mₙ) of the polymer has the effect of increasing the pore size, while lowering the molecular weight decreases the pore size. In the case of star polymers, the length of the arms, which is directly related to molecular weight, can be increased or decreased to increase or decrease the pore size. In the case of amphiphilic diblock copolymers it has been found that increasing the size of the hydrophilic block, particularly if it is composed of acid groups, such as acrylic, can increase the size of the pores more than would be expected on the basis of molecular weight effects alone. In preferred embodiments the pore size is controlled within a range of 0.4 to 3 μm.

Although the polymer solutions are generally cast from carbon disulfide or chloroform, other organic solvents that are immiscible with water. Further, a predetermined humidity may optionally be maintained by the utilisation of saturated salt solutions, as described in CRC, Handbook of Chemistry and Physics, 72 Edition, Section 15, Page 21.

Before casting the solution of polymer, it may be advantageous to include one or more additives in the polymer solution to improve the properties of the resulting polymer film. It may be advantageous to include some long chain polymer which is compatible with the particular polymer system in the solution, and which may enhance the properties of the resulting film. As mentioned above, the addition of some long chain polymer can reduce the brittleness of the resulting polymer film. Other additives, such as organic dyes, pigments and fluorescent materials may be also be added.

The number average (Mₙ) and weight average (M_{w}) weights of the polymers can be calculated using standard techniques. The polydispersity index can then be calculated from these values using the formula:

$$PDI = \frac{{M}_{w}}{{M}_{n}} .$$

For linear polymers Mₙ and M_{w} can be calculated using gel permeation chromatography or using techniques described in “Practical Polymer Analysis” by Crompton, T. R. (Publisher New York: Plenum 1993). For star polymers it is more difficult to calculate the molecular weights using this technique as the hydrodynamic volume of a star polymer of a particular molecular weight is different from the hydrodynamic volume of a linear polymer of the same molecular weight.

The methodology of the present invention allows for the preparation of porous polymer films having a desired pore size, pore regularity and/or structural integrity for a particular application. For example, where the porous polymer film is to be used as a substrate for cell growth, the size of the pores can be made to correspond to the size of the cells by selecting a polymer which has the appropriate properties to provide that pore size.

The membrane casting process should preferably be conducted in a way which provides uniformity of pore size, as well as regular spacing of pores. While it is useful to analyse the average mean pore diameter and compare between films, a similarly useful piece of information is the regularity of pore size, i.e. the degree to which pore diameters in a film are similar to other pore diameters in that film. Simple standard deviation measurements do not always capture this information, as they merely treat normally distributed data and report the deviation from that mean value. Accordingly, these measurements are not particularly useful if the distribution is bi- or multimodal.

It is believed that the film casting process should recognise regularity regardless of whether it coincides with the mean or not, and that a description of regularity should take account of regular areas, be they across the whole film or not. Of course, the ideal case would be a perfectly regular film of one pore diameter, but at this stage, the casting process is liable to produce films that depart from this ideal, hence the requirement for a quantitative determination of this departure, while recognising regular regions.

Instead of treating deviations from a mean point, it is useful to look at the differences between all data points (pore sizes). Such a measurement is the Gini Coefficient (G):

$$G = \frac{1}{2 {n}^{2} μ} {\sum }_{j = 1}^{m} {\sum }_{k = 1}^{m} {n}_{j} {n}_{k} \vert ( {y}_{j} - {y}_{k} ) \vert \qquad Equation 1$$

It sums the absolute difference between one value and all other values in a list of data (yⱼ−yₖ), then standardises this difference for both the number of such differences (n²), the mean (μ), and for counting each difference twice. That is to say, that if the data comprises values A₁, A₂, A₃ and B₁, B₂, B₃ where A₁=A₂=A₃ and B₁=B₂=B₃, then the differences considered will be (A₁−B₁), (A₁−B₂), (A₁−B₃), (B₂−A₁), (B₂−B₃) . . . and so on.

The value of the coefficient will vary between 0 (in the case where the numerator is 0, or N is infinity, and so gives the perfect equality case), and 1 (where the numerator is equal to the denominator, that is, perfect inequality).

To exemplify the inadequacy of the standard deviation (σ) calculation to identify deviations from the ideal case, a population of N pores (mean=μ) of which αN have pore diameter A, and (1−α)N have pore diameter B (where A>B) might be considered. Treating first σ, substitution yields the general result (2),

$$σ = \sqrt{\frac{α {N ( μ - A )}^{2} + ( 1 - α ) {N ( μ - B )}^{2}}{N - 1}} \qquad Equation 2$$

However, if we assume that the total number of pores considered (N) is large (i.e. N−1≈N), then N can be cancelled from both denominator and numerator:

σ=\sqrt{α(μ−A)²+(1−α)(μ−B)²} Equation 3

Similarly, G can be calculated for this population as follows (4):

$$G = \frac{α N \vert ( A - B ) \vert + ( 1 - α ) N \vert ( B - A ) \vert}{2 {N}^{2} μ} \qquad Equation 4$$

However, this can be reduced, given that:

μ=αA+(1−α)B Equation 5

When this is substituted back into the Gini equation with the proviso that A>B, this yields the general case of G for any population as described:

$$G = \frac{\vert ( A - B ) \vert}{2 N ( α ( A + B ) + B )} \qquad Equation 6$$

With minimal assumption (only that N is somewhat large), the general case of σ (3) and G (6) differ in that G encompasses N in the numerator, whereas N has no effect on σ for the same case. The exemplification might be carried further by taking the extreme situation where the population is strictly bimodal, ie. that α=0.5. With this measure, the two coefficients of variation reduce to:

$$\begin{matrix}σ = \frac{1}{2} ( A - B ) & Equation 7 \\ G = \frac{\vert ( A - B ) \vert}{N ( A + B )} & Equation 8\end{matrix}$$

It is self-evident that with constant values of pore diameters A and B, the σ equation is blind to equal regions of regular pore diameter A, or B and apportions the same degree of distribution. It should be noted at this point that one way of measuring pore diameters is to “photograph” a region of the film, and enlarge the photograph and physically measure the size of the pores in a given area. Whereas, G, with an inverse N relationship, will ‘reward’ larger sample numbers that display this bimodal (or tri-modal, or any number of ordered regions in the general case) by computing a lower G. It for this reason that G is believed to be a more appropriate measure of pore size regularity.

The molecular weight (M_{w}) of polymers preparing using living/controlled free radical polymerisation is intrinsically linked to the monomer conversion. This in turn will depend on the particular living technique being utilised, the temperature, initiator concentration, kinetics, solvent (if present) etc. If a low polydispersity index is desired, it is important to ensure that the conditions are such that the degree of polymerisation controlled by the living system is far greater than polymerisation occurring via conventional free radical processes. This will generally allow the number average molecular weight Mₙ to approach M_{w}, allowing the PDI to approach 1

It is possible to access and modify the inherent functionality of the afforded polymer prior to casting. Such a process may involve the reaction of, for example, the pendant hydroxyl groups introduced into the polymer through the use of a hydroxy containing co-monomer, with aminopropyl trimethoxy silane to transform the hydroxyl group to a primary amine. Such transformation may be monitored by a number of characterization techniques, such as chemical specific dyes.

It is also possible to modify the functionality of the polymer by accessing the inherent reactivity of the ATRP and RAFT end-groups. Both the alkyl halide and dithioester end-groups lend themselves to modification via a range of traditional chemistries. In the ATRP example the alkyl halide can be dehalogenated in a one-pot process or the halogen end groups can be transformed to other functionalities using nucleophilic substitution reactions or electrophilic addition reactions. Moreover, utilising the ability of the halogen chain end to be reactivated, radical addition reactions can be used to incorporate allyl end groups, insert one less reactive monomer unit at the chain end, or to end-cap the polymer chain (Coessens, Veerie; Pintauer, Tomislav; Matyjaszewski, Krzysztof, Prog. Polym.Sci.(2001), 26(3), 337-377.) For example, the Br end-group of a polystyrene star polymer with a glucose core, synthesised via ATRP, can be converted to a salicylester group by simply refluxing with the appropriate amount of sodium salicylate in methylene chloride.

The present invention may be utilised in a number of applications. By allowing control of pore size, these stable macroporous films may find application as substrates for cell growth and photonic band gap devices. For cell growth substrates, for instance, the topology of the substrate plays a vital role in not only triggering cell growth, but also in the stratification of the cellular layers. Even though a diverse range of monomers are conceivable in the generation of a stable macroporous films, it may be advantageous to generate a layer of another or same polymer on top of the porous substrate film. Drug delivery devices, supports for organic synthesis, biomaterials, catalysts, separation devices and electrodes are such devices for which a secondary polymer layer may be advantageous.

### DESCRIPTION OF PREFERRED EMBODIMENTS

The invention will now be described with reference to non-limiting examples and drawings. However it is to be understood that the particularity of the following description of the invention is not to supersede the generality of the invention previously described.

Referring to the drawings:

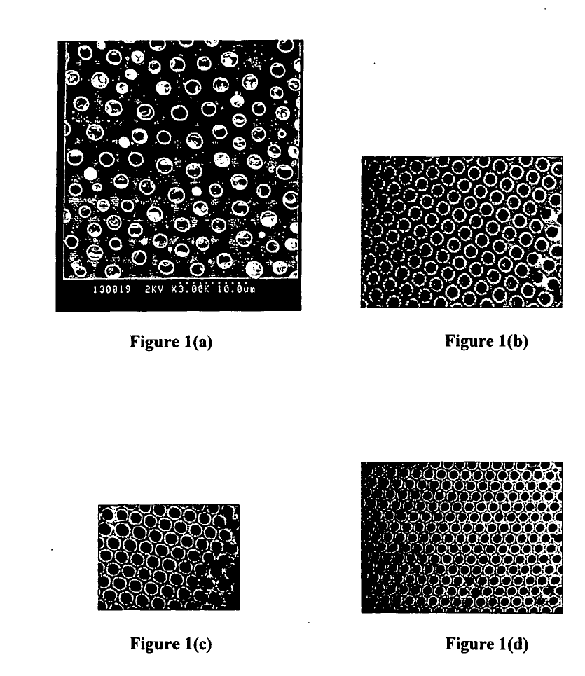

FIGS. 1(a), (b), (c) and (d) are photomicrographs of porous polymer films cast from star polymers having polystyrene arms and various cores.

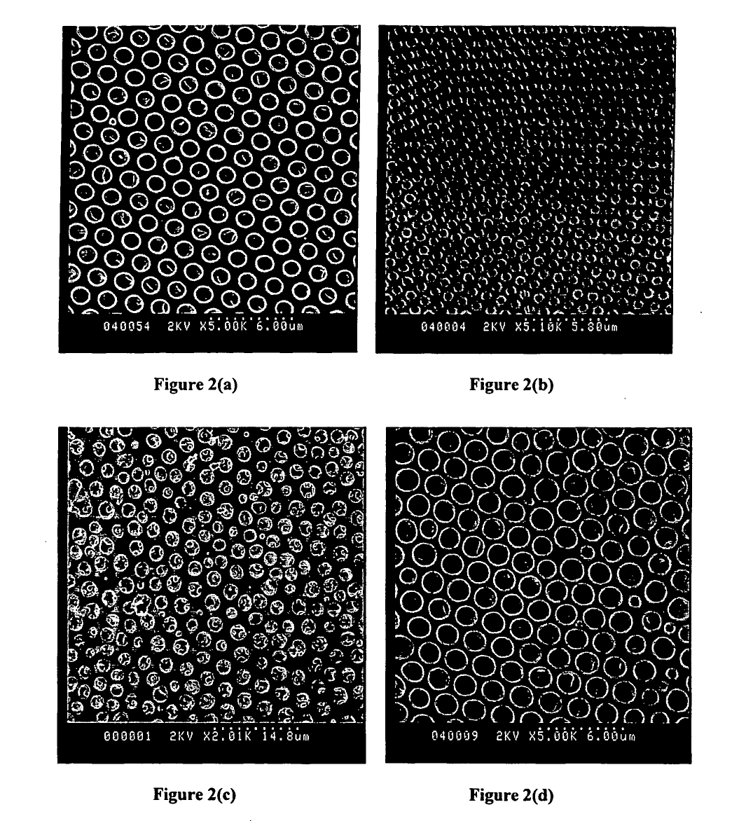

FIGS. 2(a), (b), (c) and (d) are photomicrographs of porous polymer films cast from various block copolymers.

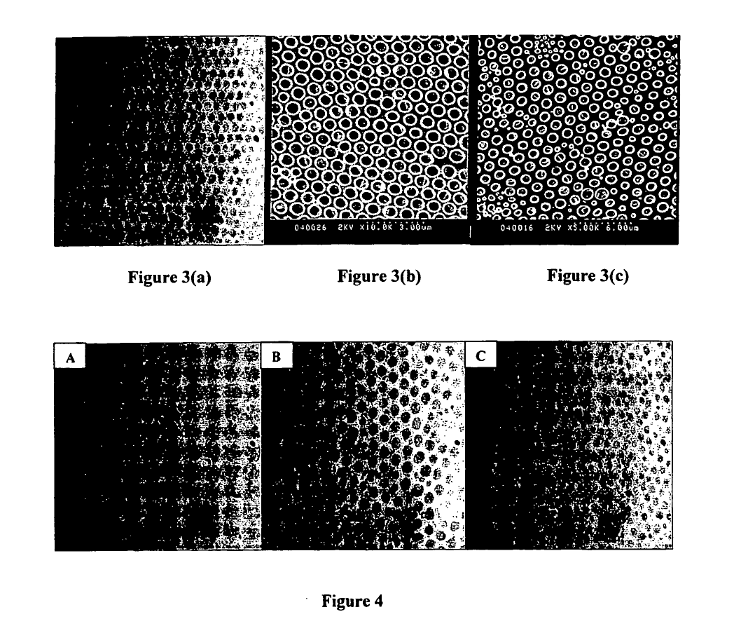

FIGS. 3(a), (b) and (c) are photomicrographs of porous polymer films cast from various BAB block copolymers.

FIG. 4 is a collection of photomicrographs of porous polymer films cast from HEMA-comb STY graft polymers.

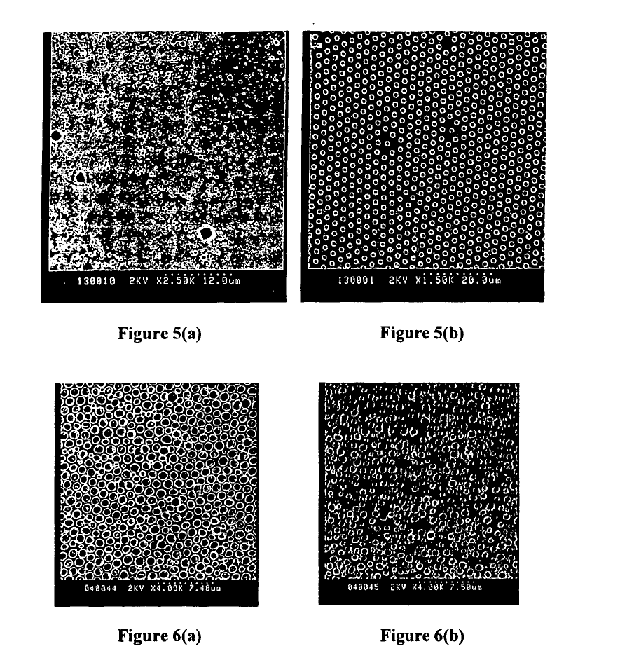

FIGS. 5(a) and (b) are photomicrographs of porous polymer films cast from blends of polystyrene star polymers (Mₙ=28000 g/mol) with low molecular weight (M_{w}=5000) and high molecular weight (M_{w}=40,000) linear polystyrene respectively.

FIGS. 6(a) and (b) are photomicrographs of porous polymer films cast from blends of block copolymers.

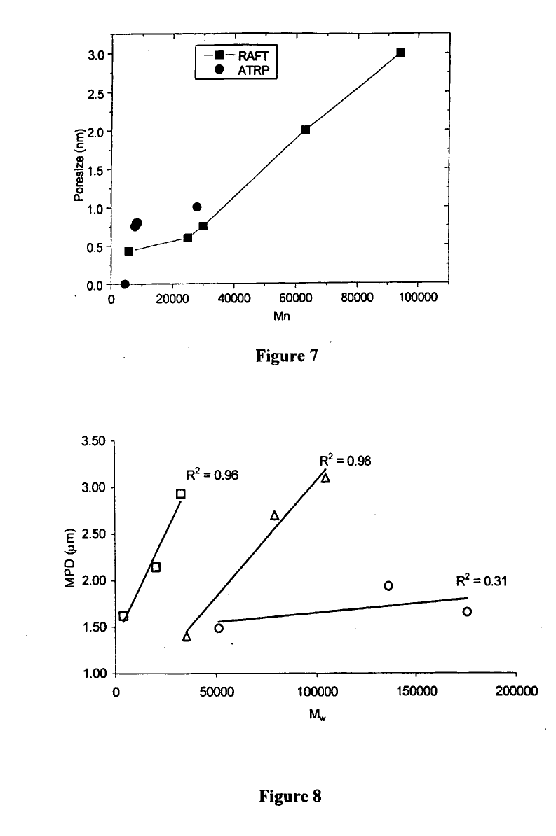

FIG. 7 is a plot of Mₙ vs pore size for polystyrene star polymers preparing using RAFT and ATRP.

FIG. 8 is a plot of mean pore diameter (MPD) vs M_{w}.

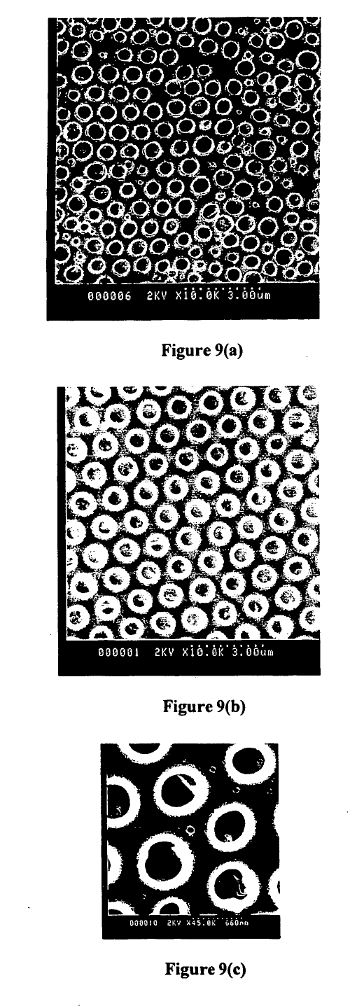

FIGS. 9(a) and (c) are photographs of porous polymer films cast from polymers in which bromine ARTP end groups have been converted to salicylester and fluorine groups respectively. FIG. 9(b) is a photomicrograph of a porous polymer film cast from the unmodified polymer used to produce the film of FIG. 9(a), the casting being performed under identical conditions.

### EXAMPLES

### Example 1

### Initiating Star Cores

(a) Hexakis(thiobenzoyl thiomethyl) benzene

Phenyl magnesium bromide was prepared from bromobenzene (10.0 g, 63 mmol) and magnesium turnings (1.4 g, 58 mmol) in dry tetrahydrofuran (50 ml). The solution was warmed to 40° C. and carbondisulfide (4.5 g, 59 mmol) was added over 15 min whilst maintaining the reaction temperature of 40° C. To the resultant dark brown mixture was added hexakis(bromomethyl)benzene (5.0 g, 47 mmol) over 15 min. The reaction temperature was raised to 50° C. and maintained at that temperature for further 3 h. Ice water (200 ml) was added and the organic products was extracted with chloroform. The organic phase was washed with water (150 ml) and dried over anhydrous magnesium sulfate. After removal of the solvent, the product, hexakis(thiobenzoyl thiomethyl) benzene was recrystallised from ethanol/chloroform.

(b) 1,2,3,4,6-Penta-O-iso-butyryl iodide-α-D-glucose (FW 1160.09 g/mol)

2-Bromo-iso-butyrylbromide (50.0 g, 0.22 mol) was added to a solution of α-D-Glucose (5 g, 0.028 mol) in a anhydrous mixture of chloroform (100 mL) and pyridine (50 mL). The solution was refluxed for 3 h whilst maintaining a dry atmosphere and then stirred at room temperature for a further 12 h. The solution was washed with ice cold water, NaOH (0.1 M) and water respectively, prior to drying over anhydrous MgSO₄. The solution was then evaporated to dryness and 5.0 g of the afforded material (5.4 mmol) dissolved in dry acetone (50 ml). Sodium iodide (5.0 g, 33 mmol) was added and the mixture stirred at room temperature for 12 h. The solvent was removed and the remaining solid transferred to a separating funnel containing chloroform and a saturated Na₂S₂O₃ aqueous solution. The organic layer was dried and the solvent was removed. The crude product was purified either by recrystallisation from methanol to afford 1,2,3,4,6-penta-O-iso-butyryl iodide-α-D-glucose.

(c) Octa-O-iso-butyryl iodide-sucrose (FW 1925.23 g/mol)

2-Bromo-iso-butyrylbromide (50.0 g, 0.22 mol) to a solution of sucrose (5 g, 0.014 mol) in anhydrous pyridine (150 mL). The solution was stirred for 24 h under a dry atmosphere at room temperature. The solution was washed with ice cold water, NaOH (0.1 M) and water, respectively prior to drying over anhydrous MgSO₄. The crude product was recrystallised from methanol/H₂O (3:1) to yield white crystals. The white crystals (5.4 mmol) were then dissolved in dry acetone (50 ml) and sodium iodide (5.0 g, 33 mmol) was added and the mixture stirred at room temperature for 12 h. The solvent was removed and the remaining solid transferred to a separating funnel containing chloroform and a saturated Na₂S₂O₃ aqueous solution. The organic layer was dried and the solvent was removed. The crude product was purified either by recrystallisation from methanol to afford octa-O-iso-butyryl iodide-sucrose.

(d) Octadeca-O-iso-butyryl bromide α-cyclodextrin

Octadeca-O-iso-butyrylbromide α-cyclodextrin was synthesised by the slow addition of 2-bromo-iso-butyrylbromide (25 g, 0.109 mol) to a vigorously stirred ice-cold (0° C.) solution of α-cyclodextrin (1.525 g, 1.57×10⁻³ mol) in pyridine (75 mL) under N₂. The solution was stirred under dry atmosphere for 24 h at 25° C. After completion of the reaction, di-ethyl-ether (70 mL) was added to dissolve the product, and the mixture washed with successive 50 mL portions of distilled water, sodium hydroxide (0.1 M) and distilled water respectively. The ether was removed by rotary evaporation and the product recrystallised from methanol/water (3:1) to yield octadeca-O-iso-butyryl bromide α-cyclodextrin as white crystals, which were collected by vacuum filtration.

(e) Hexeiocasane-o-iso-butyryl bromide-β-cyclodextrin

Hexeiocasane-O-iso-butyryl-bromide-β-cyclodextrin was synthesised by the slow addition of 2-bromo-iso-butyrylbromide (20 g, 0.087 mol) to a vigorously stirred solution of β-cyclodextrin (1.6029 g, 1.41×10⁻³ mol) in pyridine (75 mL) under N₂. The solution was stirred under dry atmosphere for 16 h at 25° C., followed by a further 8 h at 50° C. After completion of the reaction, ice-cold distilled water (100 mL) was added slowly, followed by di-ethyl-ether (70 mL) to extract the product. The mixture was washed with successive 70 mL portions of ice-cold distilled water, sodium hydroxide (0.1 M) and distilled water respectively. The ether was removed by rotary evaporation and the yellow/orange crude product recrystallised from methanol/water (3:1) to yield hexeiocasane-O-iso-butyryl bromide-β-cyclodextrin as white crystals which were collected by vacuum filtration.

### Example 2

### Synthesis of Multi-Arm Star Macromolecules

(a) Star with Polystyrene Arms and Benzene Core

Such system was synthesized employing Reversible Addition—Fragmentation Chain Transfer (RAFT). The RAFT agent, Hexakis(Thiobenzoyl Thiomethyl) Benzene, prepared above in example 1(a) and inhibitor free styrene were mixed together and degassed by bubbling nitrogen through the solution. The bottle was then sealed and brought into an oil bath thermostated at 100° C. for 64 hours and then precipitated into methanol. The resultant star polymer with polystyrene arms and a benzene core was dissolved in a small amount (approximately 50 mL) of dichloromethane and added drop-wise in a large (approximately 250 mL) vigorously stirred quantity of methanol. The precipitated polymer was then collected via vacuum filtration and dried for molecular weight analysis and film casting.

| Functionality of Core | Time (hrs) | Conversion | M_{w, GPC} | PDI |
|---|---|---|---|---|
| 6 | 64 | 0.34 | 640000 | 1.1 |
| 6 | 12.5 | 0.13 | 28000 | 1.21 |

(b) Star with Polystyrene Arms and Glucose Core

Atom Transfer Radical Polymerisation (ATRP) methodology was employed in the synthesis of the star polymer with polystyrene arms and a glucose core in the following manner. To a bottle containing a stirring bar and relative amounts of copper[I]bromide (amounting to the molar quantity of radical-centres on initiator species to be added), a mixture of 1,2,3,4,6-penta-O-iso-butyryl bromide-α-D-glucose prepared above in Example 1(b), (2.693×10⁻⁴ mol), 2,2′-dipyridyl (0.463 g, 2.96×10⁻³ mol) and deinhibited styrene (70 mL, 0.67 mol). The bottle was sealed and the mixture thoroughly degassed via a nitrogen purge for 30 min. The bottle was left under nitrogen atmosphere before being warmed to reaction temperature of 110° C. on a stirring plate. The sample bottle was heated for 16 hours. The polymerisation mixture was diluted with a small quantity of dichloromethane and passed through an aluminium oxide column to remove the catalyst and ligand. The resultant star polymer with polystyrene arms and a glucose core was recovered by precipitation drop-wise in a large (approximately 250 mL) vigorously stirred quantity of methanol. The precipitated polymer was then collected via vacuum filtration and dried for molecular weight analysis and film casting.

| Functionality of Core | Time (hrs) | Conversion | M_{w, GPC} | PDI |
|---|---|---|---|---|
| 5 | 4.5 | 0.16 | 32800 | 1.05 |
| 5 | 6.0 | 0.05 | 8500 | 1.22 |

(c) Star with Polystyrene Block Polyhydroxyethyl Methacrylate Arms and Glucose Core

Atom Transfer Radical Polymerisation (ATRP) methodology was employed in the synthesis of the star polymer with polystyrene arms and a glucose core in the following manner. 5 g (0.76×10⁻³ mol) of the STY-glucose star prepared in (b) above was dissolved in 10 g of DMF. To this stirred solution was added distilled 2-(trimethylsilyoxy)ethyl methacrylate (10 g, 49.5×10⁻³ mol), CuBr (0.107 g, 0.75×10⁻³ mol l) and 2,2′-dipyridyl (0.292 g, 1.8×10⁻³ mol). Once the solids had dissolved the solution was transferred to a polymerisation vessel and sealed. The polymerisation mixture was degassed with nitrogen gas purging for 30 minutes. The polymerisation was carried out for 2 hrs at 110° C. using a temperature controlled oil bath. After polymerisation the catalyst and ligand were removed with an alumina oxide column and precipitated drop-wise in a large (approximately 250 mL) vigorously stirred quantity of methanol. The star product was recovered via vacuum filtration and dried under reduced pressure.

2 g of the Sty-blk-HEMA_TMS star produced above was dissolved in a minimum of tetrahydrofuran (approximately 15 ml). To this stirred solution was added drop-wise a 10% methanol/hydrochloric acid mixture until a the polymer star solution turned slightly cloudy, after which more THF was added drop wise to redissolve the polymer star. The solution was stirred at 35° C. in a temperature controlled water bath for 24 hrs. The sty-blk-HEMA star was recovered by precipitation large (approximately 250 mL) vigorously stirred quantity of methanol. The precipitated polymer (Mn=40,721, PDI=1.25) was then collected via vacuum filtration and dried for molecular weight analysis and film casting.

(d) Star with Polystyrene Arms and α-cyclodextrin Core

Atom Transfer Radical Polymerisation (ATRP) methodology was employed in the synthesis of the star polymer with polystyrene arms and an alpha-cyclodextrin core in the following manner. To a bottle containing a stirring bar and relative amounts of copper[I]bromide (amounting to the molar quantity of radical-centres on initiator species to be added), a mixture of octadeca-O-iso-butyryl bromide α-cyclodextrin prepared above in Example 1(d) (2.693×10⁻⁴ mol), 2,2′-dipyridyl (0.463 g, 2.96×10⁻³ mol) and deinhibited styrene (70 mL, 0.67 mol). A sceptre was attached to the bottle and the mixture thoroughly degassed via nitrogen purge for 30 min. The bottle was left under nitrogen atmosphere before being warmed to reaction temperature of 110° C. on a stirring plate for 24 hours. The sample bottle was taken from the reaction temperature and precipitated into methanol. The resultant star polymer with polystyrene arms and an alpha-cyclodextrin core was dissolved in a small amount (approximately 50 mL) of dichloromethane before being passed through a basic alumina column and collected, drop-wise in a large (approximately 250 mL) vigorously stirred quantity of methanol. The precipitated polymer was then collected via vacuum filtration and dried for molecular weight analysis and film casting.

| Functionality of Core | Time (hrs) | Conversion | M_{w, GPC} | PDI |
|---|---|---|---|---|
| 18 | 24 | 0.78 | 170,500 | 1.32 |

(e) Star with Polystyrene Arms and β-cyclodextrin Core

Atom Transfer Radical Polymerisation (ATRP) methodology was employed in the synthesis of the star polymer with polystyrene arms and a beta-cyclodextran core in the following manner. To a bottle containing a stirring bar and relative amounts of copper[I]bromide (amounting to the molar quantity of radical-centres on initiator species to be added), a mixture of Heneiocasane-o-iso-butyryl bromide β-cyclodextrin prepared above in Example 1(e) (2.693×10⁻⁴ mol), 2,2′-dipyridyl (0.463 g, 2.96×10⁻³ mol) and de-inhibited styrene (70 mL, 0.67 mol). A sceptre was attached to the bottle and the mixture thoroughly degassed via nitrogen purge for 30 min. The bottle was left under nitrogen atmosphere before being warmed to reaction temperature of 110° C. on a stirring plate after 20 hours and precipitated into methanol. The resultant star polymer with polystyrene arms and a beta-cyclodextrin core was dissolved in a small amount (approximately 50 mL) of dichloromethane before being passed through a basic alumina column and collected, dropwise in a large (approximately 250 mL) vigorously stirred quantity of methanol. The precipitated polymer was then collected via vacuum filtration and dried for molecular weight analysis and film casting.

| Functionality of Core | Time (hrs) | Conversion | M_{w, GPC} | PDI |
|---|---|---|---|---|
| 21 | 20 | 0.38 | 316000 | 1.32 |

(f) Star with Polystyrene Arms and Polystyrene Microgel Core

Styrene was purified by passing over a column of basic aluminium oxide. 1-phenylethyl dithiobenzoate (PEDB) (0.008 mol, 2.0 g was added to a 150 ml flask, followed by the purified styrene (0.576 mol, 66.0 mL) and 2,2-azobisisobutyronitrile (AIBN, 0.0007 mol, 0.116 g) as the initiator. The resulting solution was divided among four ampoules, which were sealed then deoxygenated by purging with nitrogen for 20 minutes. The sealed ampoules were placed in a constant temperature water bath (60° C.) for three days. The reactions were stopped by placing the ampoules in an ice bath. Each of the 4 ampoules was divided among three aluminium pans which were placed in a fume cupboard overnight, followed by a vacuum oven (30° C.) for 48 hours.

| | Wt. Polymer | | GPC Results | | |
|---|---|---|---|---|---|
| Group | Recovered (g) | % Conversion | Mₙ | M_{w} | PDI |
| 1 | 5.0688 | 36.53 | 1859 | 2019 | 1.09 |
| 2 | 4.6712 | 35.38 | 1973 | 2139 | 1.08 |
| 3 | 4.8271 | 34.13 | 2069 | 2223 | 1.08 |
| 4 | 4.8410 | 35.50 | 1958 | 2115 | 1.08 |

Into a polymerisation ampoule was weighed polystyrene as synthesised above (2.0 g), toluene (8 g) and divinylbenzene (1.26 g). The divinylbenzene (DVB) used contained a mixture of para- and meta-substituted isomers and the removal of the inhibitor was via an aluminium oxide column.

AIBN (˜0.044 g) was added to the ampoule as the initiating species and the ampoule was degassed used nitrogen gas for 20 minutes, sealed and polymerised at 60° C. in a temperature controlled water bath for 48 hours. The polymerisation was stopped by placing samples in an ice bath. Following removal from the ice bath, samples were poured into an aluminium pan and placed in a fume cupboard to allow removal of toluene, to afford a star with polystyrene arms and polystyrene microgel core.

| | GPC Results | | |
|---|---|---|---|
| Reaction Time (hr) | Mₙ | M_{w} | PDI |
| 8 | 1606 | 1871 | 1.165 |
| 16 | 2469 | 3596 | 1.456 |
| 24 | 2815 | 4681 | 1.663 |
| 36 | 6219 | 24459 | 3.933 |
| 48 | 7915 | 49879 | 6.301 |

### Example 3

### Membrane Casting

Membrane casting was carried out in a humidified glove-box arrangement with controlled humidity via salt-bath solutions of between 80 and 95% relative humidity at temperatures between 19 and 25° C. A constant, regulated airflow was attached to the box at the immediate casting arena. The airflow was humidified to saturation by passing through water at room temperature and controlled between airflow 0 (off) and 15 (fully open) by compressed gas fractional gauge. Droplet sizes of approximately 10 μL were applied to glass slides via pasture pipette.

(a) Polystyrene Arms/Benzene Core

10 mg of a star with polystyrene arms and benzene core as prepared above in Example 2(a) (Mw=64,000, PDI=1.1) was dissolved in 1 ml of carbon disulfide (a final concentration of 10 mg/ml). This solution was cast onto a glass slide at 20° C. at 85% relative humidity with a moist airflow directed over the surface of the film. The macroporous film formed demonstrated a very uniform pore size as shown in FIG. 1(a).

(b) Polystyrene Arms/Glucose Core

100 mg of a star with polystyrene arms and a glucose core star as prepared above in Example 2(b) (Mw=32800, PDI=1.05), was dissolved in 1 ml of chloroform (a final concentration of 100 mg/ml). This solution was cast onto a glass slide at 20° C. at 85% relative humidity with a moist airflow directed over the surface of the film. The macroporous film formed demonstrated a very uniform pore size as shown in FIG. 1(b).

(c) Polystyrene Arms/α-Cyclodextrin Core

100 mg of a star with polystyrene arms and an α-Cyclodextrin core as prepared above in Example 2(d) (Mw=170500, PDI=1.32) was dissolved in 1 ml of chloroform (a final concentration of 100 mg/ml). This solution was cast onto a glass slide at 20° C. at 85% relative humidity with a moist airflow directed over the surface of the film. The macroporous film formed demonstrated a very uniform pore size as shown in FIG. 1(c).

(d) Polystyrene Arms/β-Cyclodextran Core

20 mg of a star with polystyrene arms and a β-Cyclodextran Core as prepared above in Example 2(e) (Mw=316,600 PDI=1.32) was dissolved in 1 ml of chloroform (a final concentration of 20 mg/ml). This solution was cast onto a glass slide at 20° C. at 85% relative humidity with a moist airflow directed over the surface of the film. The macroporous film formed demonstrated a very uniform pore size as shown in FIG. 1(d).

(e) Polystyrene Arms/Polystyrene Microgel Core

100 mg of microgel star with polystyrene arms as prepared above in Example 2(f) (Mn=7915, PDI=6.3) was dissolved in 10 ml of dichloromethane (a final concentration of 10 mg/ml). This solution was cast onto a glass slide at 20° C. at 85% relative humidity with a moist airflow directed over the surface of the film. The macroporous film formed demonstrated a very uniform pore size as shown in FIG. 1(e).

### Example 4

### A-Block Synthesis

(a) Styrene(STY) Macromer via RAFT

(i) A stock solution of styrene (60 ml), AIBN (34.4 mg) and cumyldithiobenzoate (40 mg) was prepared. The mixture was then transferred into polymerisation ampoules, sealed and degassed. The reaction was heated out at 60° C. in a temperature controlled water bath. The polymerisation was quenched at predetermined times and the macromer recovered by evaporation under reduced pressure.

| Reaction | | |
|---|---|---|
| Time | Mn | PDI |
| 3.5 hrs | 8572 | 1.12 |
| 18 hrs | 53542 | 1.10 |
| 22 hrs | 72,307 | 1.15 |

(ii) A stock solution of styrene (60 ml), AIBN (16.9 mg) and phenylethyl dithiobenzoate (137 mg) was prepared. The mixture was then transferred into polymerisation ampoules, sealed and degassed. The reaction was heated out at 60° C. in a temperature controlled water bath. The polymerisation was quenched at predetermined times and the macromer recovered by evaporation under reduced pressure.

| Reaction | | |
|---|---|---|
| Time | Mn | PDI |
| 22 hrs | 18745 | 1.10 |
| 29.5 hrs | 22271 | 1.09 |

(b) Hydroxyethyl Methacrylate(HEMA) Macromer via RAFT

A stock solution of 10.5 ml HEMA in 19.5 ml DMF with AIBN (30 mg) and cumyldithiobenzoate (60 mg) were added to the solution in a polymerisation ampoule. Dissolved oxygen was removed from the reaction solution by bubbling with nitrogen for 20 minutes prior to immersion in a water bath kept at 60° C. The reaction was heated out at 60° C. in a temperature controlled water bath. The polymerisation was quenched after 90 min and the HEMA macromer (Mn=11336, PDI=1.2) recovered by evaporation under reduced pressure.

(c) Hydroxyethyl Acrylate(HEA) Macromer via RAFT

A stock solution of 10.5 ml HEA in 19.5 ml DMF was prepared and AIBN (30 mg) and cumyldithiobenzoate (60 mg) were added to the stirred solution. The solution was then transferred into a polymerisation ampoule. Dissolved oxygen was removed from the reaction solution by purging with nitrogen for 20 minutes prior to immersion in a water bath kept at 60° C. The reaction was carried out at 60° C. in a temperature controlled water bath for 8 hrs. The HEA-macromer (Mn=30757, PD=1.076) was recovered by evaporation under reduced pressure.

(d) Methyl Methacrylate(MMA) Macromer via RAFT

A stock solution of 30 ml of MMA with AIBN (30 mg) and cumyldithiobenzoate (60 mg) was prepared. The solution was then transferred into 2 polymerisation ampoules. Dissolved oxygen was removed from the reaction solution by purging with nitrogen for 20 minutes prior to immersion in a water bath kept at 60° C. The reaction was heated out at 60° C. in a temperature controlled water bath. The polymerisation was quenched at predetermined times and the macromer recovered by evaporation under reduced pressure.

| Reaction | | |
|---|---|---|
| Time (hrs) | Mn | PDI |
| 3 | 15438 | 1.25 |
| 5 | 27121 | 1.15 |

(e) Bifunctional Polystyrene Macromer via ATRP

0.3695 g of α,α′-dibromo-p-xylene (1.4 mmol), 0.4017 g CuBr (2.8 mmol) and 0.9946 g N-propyl-2-pyridylmethanimine was dissolved in 76 ml of styrene, and the solution degassed by three freeze-pump-thaw cycles. The polymerization was carried out at 90° C. for 3 hrs. The telechelic halogen end-functional polystyrene macromer was recovered from the polymerisation mixture by precipitation into methanol and further purified by repeated precipitation from THF solution into methanol to afford the styrene bifunctional macroinitiator (Mn=5520, PDI=1.2).

### Example 5

### B-Block Synthesis

(a) HEMA-blk-STY Synthesis

A solution containing 0.1544 g of HEMA macromer prepared above in Example 4(b) (Mn=11336, PDI=I.I), Styrene (2 ml), AIBN(6 mg ) in DMF (4 ml) was prepared. The mixture was then transferred into glass ampoule, sealed and degassed by nitrogen gas bubbling. The polymerisation was carried out at 60° C. in a temperature controlled water bath for 75 hrs 10 min. The HEMA-blk-STY polymer was recovered by evaporation under reduced pressure. The final block molecular weight composition was determined by GPC to be Mn=14413 and PDI=1.27. A porous polymer film cast from CS₂ (20 mg/ml) is shown in FIG. 2(a).

(b) STY-blk-DMA Synthesis

(i) A solution of 1.5 g of styrene macromer as prepared above in Example 4(a)(i) (Mn=8572, PD=1.12), DMA (6 ml), CDTB(32 mg), AIBN (16 mg) in DMF(10 ml). The mixture was then transferred into a polymerisation ampoule, sealed and degassed The polymerisation was carried out at 60° C. in a temperature controlled water bath. The polymerisation was quenched after 4 hrs and the STY-blk-DMA (Mn=35508) polymer was recovered by evaporation under reduced pressure. A porous polymer film cast from CS₂ (10 mg/ml) is shown in FIG. 2(b).

(ii) A solution of 0.901 g of styrene macromer as prepared above in Example 4(a)(i) (Mn=72307, PD=1.15), DMA (3.8 ml), CDTB(24 mg), AIBN (12 mg) in DMF(8 ml). The mixture was then transferred into a polymerisation ampoule, sealed and degassed by bubbling with nitrogen gas for 30 minutes.

The polymerisation was carried out at 60° C. in a temperature controlled water bath. The polymerisation was quenched after 3 hrs and the STY-blk-DMA (Mn=81069) polymer was recovered by evaporation under reduced pressure.

(iii) A solution of 1.3698 g of Styrene macromer as prepared above in Example 4(a)(ii) (Mn=18745, PD=1.15), DMA (2 ml), CDTB(38.6 mg), AIBN (13.4 mg) in DMF(5 ml). The mixture was then transferred into a polymerisation ampoule, sealed and degassed by bubbling with nitrogen gas for 30 minutes. The polymerisation was carried out at 60° C. in a temperature controlled water bath. The polymerisation was quenched after 6 hrs 25 min and the STY-blk-DMA (Mn=51686) polymer was recovered by evaporation under reduced pressure.

(c) HEA-blk-STY Synthesis

Poly (HEA-blk-STY) was synthesised by the addition of 0.3043 g of HEA macromer prepared above in Example 4(c) (Mn=30757, PD=1.076), Styrene (2 ml), AIBN (3 mg), CDTB (3.5 mg) to DMF (2 ml). The mixture was then transferred into a polymerisation ampoule, sealed and degassed by bubbling with nitrogen gas for 30 minutes. The reaction was carried out at 60° C. for 77 hours. To yield HEA-blk-STY polymer (Mn=41937, PDI=1.174). A porous polymer film cast from CS₂ (20 mg/ml) is shown in FIG. 2(c).

(d) STY-blk-AA Synthesis

(i) Poly (STY-block-AA) was synthesised by the addition of 1.59 g of styrene macromer as prepared above in Example 4(a)(i) (Mn=53542, PDI=1.12), acrylic acid (3 ml), AIBN (0.9 mg), in DMF (11.4 ml). The mixture was then transferred into glass ampoules, sealed and degassed by bubbling with nitrogen gas for 30 minutes. The reaction was carried out at 60° C. Samples were quenched at appropriate time intervals and the block polymer was recovered by evaporation under reduced pressure.

| Reaction | |
|---|---|
| time (h) | Mn |
| 0 | 53542 |
| 3 | 70509 |
| 4.5 | 76807 |
| 5.75 | 81028 |

A porous polymer cast from CS₂ (10 mg/ml, Mₙ=81028) is shown in FIG. 2(d).

(ii) Poly (STY-block-AA) was synthesised by the addition of 1.59 g of styrene macromer as prepared above in Example 4(a)(ii) (Mn=22271, PDI=1.09), acrylic acid (3 ml), AIBN (0.9 mg), in DMF (11.4 ml). The mixture was then transferred into a polymerisation ampoule, sealed and degassed by bubbling with nitrogen gas for 30 minutes. The reaction was carried out at 60° C. and samples were quenched after 2.5 hours. The block polymer recovered by evaporation at reduced pressure.

| | |
|---|---|
| Reaction | |
| time (h) | Mn |

| | | |
|---|---|---|
| 0 | | 22271 |
| 2.5 | hrs | 32844 |

(e) MMA-blk-AA Synthesis

0.7705 g of MMA macromer as prepared above in example 4(d) (Mn=15438, PDI=1.25), acrylic acid (3.1 ml) and AIBN (0.9 mg) were added to toluene (7.7 ml). The mixture was then transferred into two glass ampoules and sealed. Dissolved oxygen was removed from the solution by bubbling with nitrogen for 20 minutes. The reaction was carried out at 60° C. in a temperature controlled water bath. The polymerisation was quenched at predetermined times and the macromer recovered by evaporation under reduced pressure to yield the following MMA-blk-AA block polymers.

| Reaction | |
|---|---|
| time (h) | Mn |
| 0 | 15438 |
| 2 | 20065 |
| 4 | 29081 |

(f) MMA-blk-DMA Synthesis

1.46 g of MMA macromer prepared above in Example 4(d) (Mn=27121, PDI=1.15), DMA (3.4 ml) and AIBN (0.9 mg) were added to toluene (9.8 ml). The mixture was then transferred into glass ampoules and sealed. Dissolved oxygen was removed from the solution by bubbling with nitrogen for 20 minutes. The reaction was carried out at 60° C. in a temperature controlled water bath for. The polymerisation was quenched at predetermined times and the macromer recovered by evaporation under reduced pressure to yield the following MMA-blk-DMA block polymers.

| Reaction Time (hr) | Mn |
|---|---|
| 0 | 27121 |
| 1 | 37390 |
| 1.5 | 41284 |
| 2 | 43135 |

(g) HEMA-bik-STY-blk-HEMA Synthesis

To a 20 mL flask was added styrene bifunctional macroinitiator (0.5 g, 0.362 mmoles) prepared above in Example 4(e) (Mn=5520), 52.0 mg (0.362 mmoles) CuBr, 124 mg (0.797 mmoles) of 2,2′-bipyridyl (bpy). 10 mL of dry DMF was added to the flask and 3.66 g (3.62 mmoles) of 2-(Trimethylsyliloxy) Ethyl Methacrylate. The flask was sealed with a rubber septa and the mixture degassed by nitrogen bubbling for 30 minutes. The polymerisation was carried out at 80° C. or 110° C. for the desired reaction times.

The polymer was purified by passing the polymer mixture through a basic alumina column followed by precipitation in methanol. The recovered polymer was redissolved in 10 mL THF and 5mL of acidified methanol (3:1 methanol:HCl(32%)) was added drop-wise. The polymer solution was stirred for 24 hours to completely hydrolyse the polymer. The resulting polymer was reprecipitated in methanol and dried in vacuum oven overnight prior to casting process.

| Reaction Condition | Mn | PDI |
|---|---|---|
| 80° C., 1 hr | 8918 | 1.220 |
| 80° C., 2 hrs | 9517 | 1.257 |
| 80° C., 3 hrs | 10414 | 1.293 |
| 110° C., 2.5 hrs | 12472 | 1.396 |
| 110° C., 4 hrs | 17335 | 1.383 |
| 110° C., 1 hr | 16646 | 1.173 |

(h) MAA-blk-STY-blk-MAA Synthesis

To a 20 mL flask was added 0.5 g (0.362 mmol) of styrene bifunctional macroinitiator prepared above in Example 4(e) (Mn=5520), CuBr (52.0 mg, 0.362 mmol), 2,2′ bipyridyl (124 mg, 0.797 mmol) and 10 mL dry DMF. To the stirred reaction mixture was added trimethylsilyloxy methacrylate (2.87 g, 3.62 mmole). This was allowed to stir until all solids had dissolved. The flask was sealed with a rubber septa and the mixture degassed under nitrogen for 30 minutes. The reaction mixture was then heated at 110° C. for desired reaction time. The polymer was then purified by passing the polymer mixture through a basic alumina column followed by precipitation in methanol. The recovered polymer was redissolved in 10 mL THF and 5mL of acidified methanol (3:1 methanol:HCl (32%)) was added drop-wise. The polymer solution was stirred for 24 hours to completely hydrolyse the polymer. The resulting polymer was reprecipitated in methanol and dried in vacuum oven overnight prior to casting process.

| Reaction Condition | Mn | PDI |
|---|---|---|
| 110° C., 1 hr | 8998 | 1.206 |

(i) DMA-blk-STY-blk-DMA Synthesis

To a 50 mL flask was added 1.0 g of styrene bifunctional macroinitiator prepared above in Example 4(e) (Mn=5520), CuBr (34.2 mg), 2,2′ bipyridyl (82.0 mg), cumyl dithiobenzoate (CDTB) (0.65 g) and 20 mL dry DMF. The flask was stoppered with a rubber septa and degassed by nitrogen bubbling for 30 minutes. The reaction mixture was heated for 48 hours at 100° C. to afford the capped dithiobenzoate polystyrene (CDTB-PSTY-CDTB). A mixture of 0.50 g of CDTB-PSTY-CDTB, 5.20 g DMA, and 5.94 mg AIBN was taken up in 50 mL of dry DMF, degassed under nitrogen for 20 minutes and then heated at 60° C. for desired reaction time to afford the BAB block material DMA-blk-STY-blk-DMA.

| Reaction Time (hrs) | Mn | PDI |
|---|---|---|
| 1.5 | 8955 | 1.255 |
| 3.5 | 9771 | 1.288 |
| 5.5 | 12929 | 1.698 |
| 6.5 | 15268 | 2.122 |

### Example 6

### BAB Block Systems

Porous polymer films were cast from the BAB block systems of examples 5(g), (h) and (i) under the following conditions:

| | B-b-A-b-B blocks | | |
|---|---|---|---|
| | HEMA-b- | MAA-b- | DMA-b- |
| | STY-b- | STY-b- | STY-b- |
| Description | HEMA 5(g) | MAA 5(h) | DMA 5(i) |
| Mn | 8918 | 8998 | 8955 |
| PDI | 1.219 | 1.206 | 1.225 |
| Casting conditions: | | | |
| Solvent used | CS₂ | CH₂Cl₂ | CH₂Cl₂ |
| Polymer | 10 | 20 | 10 |
| concentration | | | |
| mg/mL) | | | |
| Humidity (%) | 95 | 90 | 90 |
| Temperature (° C.) | 23 | 25 | 25 |

The porous polymer films are shown in FIGS. 3(a), (b) and (c) respectively.

### Example 7

### Graft Polymer Synthesis

(a) Preparation of Poly(2-hydroxyethyl methacrylate) Backbone

To a 50 mL flask was add 12 g of vacuum distilled HEMA, 30.0 mg AIBN, 90.0 mg cumyl dithiobenzoate and 30 mL dry DMF. The flask was sealed with a rubber septa and the mixture degassed by nitrogen bubbling for 30 minutes. The polymerisation mixture was heated at 60° C. for 3.5 hours. The after polymerisation the mixture was diluted with 60 mL THF and the polymer precipitated in a CHCl₃/n-Hexane mixture (50:50). The recovered polymer was dried under reduced pressure to afford the PHEMA backbone with a Mn=23000, PD=1.182.

1.0 g of the PHEMA backbone prepared above was taken up into 20 mL of dry DMF. Under a nitrogen blanket 6.5 mL of 2-bromoisobutyryl bromide was added to the solution drop wise with vigorous stirring. The mixture was allowed to react at room temperature for 48 hours with slow stirring. The resulting PHEMA macroinitiator was precipitated in water, dried and redissolved in CHCl₃ where it was reprecipitated in n-hexane 3 times to afford a polymer of Ma=23677 and PD=1.202.

(b) Poly(2-hydroxyethyl methacrylate)-comb-polystyrene Synthesis

0.30 g of the Poly(2-hydroxyethyl methacrylate) macroinitiator prepared above, 0.79 g CuBr, and 0.33 g 2,2′-bipyridyl (bpy) were dissolved in 5 mL of dry DMF. To this solution was added 25 mL of de-inhibited styrene and 1.5 mL of anisole. The polymerisation mixture was transferred to polymerisation ampoules, sealed with rubber septa and degassed with nitrogen bubbling for 30 minutes. The polymerisations were carried out at 110° C. and 80° C. for the desired period of time. The ligand and catalyst were removed by passing the polymerisation mixture through a basic alumina column. The comb polymer product was recovered by precipitation into methanol.

| | Reaction Conditions | Mn | PDI |
|---|---|---|---|
| A | 47 hrs, 80° C. | 113483 | 1.222 |
| B | 20 hrs, 110° C. | 136824 | 1.246 |
| C | 47 hrs, 110° C. | 187503 | 1.144 |

Porous polymer films were cast from these graft polymers under the following conditions:

| | PHEMA-comb-PSTY | | |
|---|---|---|---|
| Description | A | B | C |
| Mn | 113483 | 136824 | 187503 |
| PDI | 1.222 | 1.246 | 1.144 |
| Casting conditions: | | | |
| Solvent | CS₂ | CS₂ | CS₂ |
| Polymer concentration | 20 | 10 | 10 |
| (mg/mL) | | | |
| Humidity (%) | 95 | 95 | 95 |
| Temperature (° C.) | 23 | 23 | 23 |

The porous polymer films are shown in FIG. 4.

### Example 8

### Blends

(a) Casting Outcome Afforded by Star and Linear Polymers

Polystyrene of different molecular sizes was added to a polystyrene star as prepared in example 2(a) with molecular weight of 28000 g/mol. One film was cast using 10% of low M_{w} (M_{w}=5000) linear polystyrene while anther was prepared with 10% of 40,000 g/mol in FIGS. 5(a) and (b) respectively. A strong irregularity of the structure was obtained with low molecular weights, while higher molecular weights of the linear chain

(b) Casting Outcome Afforded by Blending Block/Block and Block/Linear Polymers

The table below shows the blend composition of CS₂ casting solutions prepared from appropriate block and linear polymers to give a final concentration of 10 mg/ml.

| Sam- | | | | | |
|---|---|---|---|---|---|
| ple | Polymer 1 | Polymer 2 | Mn₁ | Mn₂ | Ratio |
| 1 | STY- | STY-DMA | 8247-37170 | 18745-32941 | 50:50 |
| | DMA | | | | |
| 2 | STY- | STY-HEMA | 18745-32941 | 3077-11336 | 50:50 |
| | DMA | | | | |
| 3 | STY- | STY | 3077-11336 | 30898 | 90:10 |
| | HEMA | | | | |

The porous polymer films prepared from samples 1 and 2 are shown in FIGS. 6(a) and (b) respectively.

### Example 9

### Pore Size Control

(a) Influence of Molecular Weight on Pore Size

The pore size of the structure increases with molecular weight of the star polymer. Therefore a desired pore size can be simply obtained by using a star polymer with the right molecular weight. The relationship between molecular weight (Mₙ) and pore size for polystyrene star polymers prepared by RAFT and ATRP is shown graphically in FIG. 7.

(b) Gini Coefficients

Optical micrographs of porous polymer films were taken at a standard magnification which were then submitted to image analysis software to yield Mean Pore Diameter (MPD) values. The individual pore diameters were used to produce Gini Coefficients (G) for each film and the results tabulated below.

The casting was performed at a concentration of 100 mg/ml in trichloromethane at constant airflow and a relative humidity of greater than 80%. The polymers comprised polystyrene arms and the following cores:

| | |
|---|---|
| A | α-D-glucose |
| B | α-cyclodextrin |
| C | β-cyclodextrin |

The molecular weight of the star polymers was derived from GPC against a styrene standard with the theoretical molecular weight of arms calculated by NMR, end-group analysis techniques.

RESULTS

| | | | MPD | |
|---|---|---|---|---|
| Polymer | M_{w, GPC} | PD | (□m) | G |
| □ | 4060 | 1.48 | 1.62 | 0.23 |
| | 20400 | 1.06 | 2.15 | 0.19 |
| | 32900 | 1.05 | 2.93 | 0.06 |
| | 57700 | 1.07 | 2.37 | 0.13 |
| □ | 35400 | 1.11 | 1.40 | 0.17 |
| | 79600 | 1.05 | 2.69 | 0.24 |
| | 104900 | 1.13 | 3.09 | 0.14 |
| | 146000 | 1.14 | 1.66 | 0.22 |
| | 170500 | 1.17 | 2.95 | 0.28 |
| C | 24400 | 1.16 | 2.09 | 0.15 |
| | 51400 | 1.27 | 1.48 | 0.17 |
| | 136400 | 1.18 | 1.94 | 0.17 |
| | 175700 | 1.18 | 1.65 | 0.29 |

When graphically represented, the above data indicates a relationship between Molecular weight of the macromolecule and the mean pore size diameter. A graphical representation is shown in FIG. 8, where MPD is plotted as a function of M_{w} for low molecular weight (linear regression lines fitted, with coefficients to 2 decimal places). (□)=A, (Δ)=B, (o)=C.

(c) Pore Size Control through End-Group Modification

(i) Conversion of ATRP bromine end-group to salicylester 1 g Polystyrene (Example 2(b)) (Glucose core, Mₙ=8500, bromide end-groups: 5.9×10⁻⁴ mol) was mixed with 1 g (6.25×10⁻³ mol) Sodium salicylate in 50 ml methylene chloride and refluxed for 3 d. The precipitate was filtered off and washed with methylene chloride several times. The solution was poured into Methanol to isolate the product. The modified star was cast from a 10 mg/ml solution of carbon disulphide to yield a porous film with a pore size of 530 nm as shown in FIG. 9(a). The unmodified star cast under identical casting conditions yielded a porous film with a pore size of 650 nm and is shown for comparison as FIG. 9(b).

(ii) Conversion of ATRP Bromine End-group to Fluorinated End-group

18 mg NaH (80%, 5.9×10⁻⁴ mol) was added to a solution of 235 mg (5.9×10⁻⁴ mol) 2,2,3,3,4,4,5,5,6,6,7,7,8,8,8-Pentadecafluoro-1-octanol in 25 ml dry THF. After the mixture was stirred for 3 h, 1 g Polystyrene (Example 2(b)) (glucose core, Mₙ=8500, bromide end-groups: 5.9×10⁻⁴ mol) was added. The mixture was refluxed for 24 h and finally precipitated into water/methanol. After washing the product with methanol, the mineral oil (of NaH) was removed by washing the precipitate with hexane. The product was dissolved into methylene chloride and precipitated into diethyl ether. The modified star was cast from a 10 mg/ml solution of carbon disulphide to yield a porous film with a pore size of 450 nm as shown in FIG. 9(c).

(iii) Conversion to RAFT-thioester End-group

5 g (0.76×10⁻³ mol) of the STY-glucose star prepared above was dissolved in 10 g of DMF. To this stirred solution was added cumyldithiobenzoate (1.064 g, 3.8×10⁻³ mol ) CuBr (0.107 g, 0.75×10⁻³ mol l) and 2,2′-dipyridyl (0.292 g, ×10⁻³ mol). Once the solids had dissolved the solution was transferred to a polymerisation vessel and sealed. The reaction mixture was degassed with nitrogen gas purging for 30 minutes. The reaction was carried out for overnight at 100° C. using a temperature controlled oil bath. The catalyst and ligand were removed with an alumina oxide column and the thioester capped styrene star precipitated drop-wise in a large (approximately 250 mL) vigorously stirred quantity of methanol. The pale pink product was recovered via vacuum filtration and dried under reduced pressure.

(iv) Controlling pore size through choice of hydrophilic monomer and block size

| | Mn (M_{A}-M_{B}) | Pore Size μm |
|---|---|---|
| STY-blk-DMA | 35508 (8572-26936) | 0.34 |
| | 51686 (18745-32941) | 0.63 |
| | 81069 (72307-8762) | 0.90 |
| STY-blk-AA | 32844 (22271-10573) | 0.82 |
| | 70509 (53542-16967) | 1.76 |
| | 76807 (53542-23265) | 2.14 |
| | 81028 (53542-27486) | 3.92 |

(v) Controlling Pore Size through Blending

Different amounts of linear polystyrene (Mn=40000, PDI=1.1) were added to the casting solution of a polystyrene star (5 arm glucose core via ATRP, molecular weight of 28000 g/mol) to give a final casting solution composition of 10 mg/ml in carbon disulphide. A strong dependence on the pore size on the amount of linear component was observed as shown in the Table below.

| Star Polymer | Linear Polymer | Pore Size Size μm |
|---|---|---|
| 80% | 20% | 1.1 |
| 70% | 30% | 2.5 |
| 50% | 50% | 4.0 |

Those skilled in the art will appreciate that the invention described herein is susceptible to variations and modifications other than those specifically described. It is to be understood that the invention includes all such variations and modifications which fall within the spirit and scope. The invention also includes all of the steps, features, compositions and compounds referred to or indicated in this specification, individually or collectively, and any and all combinations of any two or more of said steps or features.

1. A method for preparing a porous polymer film comprising:
providing a solution of star, block or graft polymer in a casting solvent, said polymer being prepared by ARTP or RAFT polymerisation, and
casting a porous polymer film from said solution.

2. A method for preparing a porous polymer film comprising:
providing a solution of a graft polymer in a casting solvent, said polymer being preparing by living/controlled polymerisation, and
casting a porous polymer film from said solution.

3. A method of preparing a porous polymer film comprising:
providing a solution of a microgel in a casting solvent, and
casting a porous polymer film from said solution.

4. A method of enhancing the uniformity of pore size in porous polymer film prepared from a star, block or graft polymer preparing by living/controlled polymerisation comprising:
incorporating a linear polymer into a solution of said polymer in a casting solvent, and
casting a porous polymer film from said solution.

5. A method of preparing a porous polymer film having regularly spaced pores of substantially uniform pore size comprising:
providing a solution of star, block or graft polymer in a casting solvent, said polymer being prepared by ATRP, and
casting said porous polymer film from said solution.

6. A method of facilitating the casting of a porous polymer film comprising:
providing a solution of said star, block or graft copolymer prepared by living/controlled polymerisation and having a low polydispersity index, and
casting a porous polymer film from said solution.

7. A method of controlling the pore size and/or pore regularity of a porous polymer film comprising:
providing a star, block or graft copolymer in a solvent, said polymer being prepared by ATRP or RAFT polymerisation,
modifying at least a portion of ATRP or RAFT end groups of said polymer to provide desired end groups, and
casting a porous polymer film from said solvent or from a solution of the polymer in a solvent suitable for casting.

8. A method of increasing the size of the pores of a porous polymer film prepared from an amphiphilic diblock copolymer prepared by living/controlled polymerisation, said method comprising:
increasing the size of the hydrophilic block of said amphiphilic diblock copolymer, and
casting a porous polymer film from a solution of the modified polymer in a casting solvent.

9. A method of increasing the size of the pores of a porous polymer film prepared from a star polymer prepared by living/controlled polymerisation, said method comprising:
providing a solution of said star polymer and a long chain linear polymer in a casting solvent, and
casting a porous polymer film from said solution,
wherein the long chain linear polymer is of such a size and is present in such an amount as to increase the pore size of the porous polymer film relative to the pore size of a film cast under identical conditions in the absence of said long chain linear polymer.
